(19) United States
(12) Patent Application Publication
(10) Pub. No.: US 2019/0240729 A1
(43) Pub. Date: Aug. 8, 2019

(54) SURFACE TREATMENT METAL POWDER FOR LASER SINTERING

(71) Applicant: JX Nippon Mining & Metals Corporation, Tokyo (JP)

(72) Inventors: Hideki FURUSAWA, Ibaraki (JP); Kenji SATO, Tokyo (JP); Terumasa MORIYAMA, Ibaraki (JP)

(73) Assignee: JX Nippon Mining & Metals Corporation, Tokyo (JP)

(21) Appl. No.: 16/336,323

(22) PCT Filed: Sep. 29, 2017
(86) PCT No.: PCT/JP2017/035630

§ 371 Date: Mar. 25, 2019

(30) Foreign Application Priority Data
Sep. 29, 2016 (JP) 2016190722

(51) Int. Cl. B22F 1/00; B33Y 10/00; B33Y 70/00; B22F 1/02; B22F 3/105

(52) U.S. Cl. CPC B22F 1/0014; B33Y 10/00; B33Y 70/00; B22F 2301/255; B22F 3/1055; B22F 2304/10; B22F 2301/10; B22F 1/02

(57) ABSTRACT

A surface treatment metal powder having any of the following characteristics is provided as a metal powder that can be suitably used for metal AM and has excellent laser absorbing characteristics: the brightness L* of the surface is 0-50; the color difference ΔEab of the surface is 40 or more; the color difference ΔL of the surface is −35 or less; the color difference Δa of the surface is 20 or less; and the color difference Δb of the surface is 20 or less (when determined on the basis of the object color of a white plate (brightness L*=94.14, color coordinate a*=−0.90, color coordinate b*=0.24)).

### TECHNICAL FIELD

The present invention relates to a surface-treated metal powder for laser sintering.

### BACKGROUND ART

Metal AM (Additive Manufacturing, 3D printing) is attracting attention. The AM is a shaping process that shapes a three-dimensional shape while adding materials. The materials include various materials such as resins, metals, paper, gypsum, foods, sands and the like. For the metal AM, a powder sintering laminate shaping method is performed (Patent Document 1), for example.

### CITATION LIST

### Patent Literature

Patent Document 1: Japanese Patent Application Publication No. 2016-102229 A

### SUMMARY OF INVENTION

### Technical Problem

In metal AM, when metal powder such as copper powder is used for a selective laser melting method (SLM), the laser is reflected on a surface of the metal powder, causing problems that absorption of the laser may hardly occur, and sintering hardly occurs.

Accordingly, an object of the present invention is to provide a metal powder having improved laser absorbability, which can be suitably used for metal AM.

### Solution to Problem

As a result of intensive studies, the present inventors have found that the above object can be achieved by the following surface-treated metal powder, and have arrived at the present invention.

Thus, the present invention includes the following aspects (1) to (25):

(1)

A surface-treated metal powder, wherein a surface of the surface-treated metal powder has a lightness L* of 0 or more and 50 or less,

(2)

The surface-treated metal powder according to aspect (1), wherein a surface of the surface-treated metal powder has a color coordinate a* of 20 or less.

(3)

The surface-treated metal powder according to aspect (1), wherein a surface of the surface-treated metal powder has a color coordinate b* of 20 or less.

(4)

A surface-treated metal powder, wherein a surface of the surface-treated metal powder has a color difference ΔEab of 40 or more, based on an object color of a white plate (lightness L*=94.14, color coordinate a*=−0.90, and color coordinate b*=0.24).

(5)

A surface-treated metal powder, wherein a surface of the surface-treated metal powder has a color difference ΔL of −35 or less, based on an object color of a white plate (lightness L*=94.14, color coordinate a*=−0.90, and color coordinate b*=0.24).

(6)

A surface-treated metal powder, wherein a surface of the surface-treated metal powder has a color difference Δa of 20 or less, based on an object color of a white plate (lightness L*=94.14, color coordinate a*=−0.90, and color coordinate b*=0.24).

(7)

A surface-treated metal powder, wherein a surface of the surface-treated metal powder has a color difference Δb of 20 or less, based on an object color of a white plate (lightness L*=94.14, color coordinate a*=−0.90, and color coordinate b*=0.24).

(8)

The surface-treated metal powder according to any one of aspects (1) to (7), wherein the surface-treated metal powder has D50 of 200 μm or less.

(9)

The surface-treated metal powder according to aspect (8), wherein the D50 is 100 μm or less.

(10)

The surface-treated metal powder according to aspect (8), wherein the D50 is 50 μm or less.

(11)

The surface-treated metal powder according to any one of aspects (1) to (10), wherein the surface-treated metal powder comprises a surface-treated layer containing one or more elements selected from the group consisting of Ni, Zn, P, W, Sn, Bi, Co, As, Mo, Fe, Cr, V, Ti, Mn, Mg, Si, In and Al.

(12)

The surface-treated metal powder according to aspect (11), wherein the surface-treated layer comprises at least one of Cu and Au.

(13)

The surface-treated metal powder according to aspect (11) or (12), wherein the surface-treated layer comprises a roughening-plated layer.

(14)

The surface-treated metal powder according to any one of aspects (1) to (13), wherein the metal in the surface-treated metal powder is copper or a copper alloy.

(15)

A method for producing a laser sintered body, comprising a step of laser-sintering the surface-treated metal powder according to any one of aspects (1) to (14) by irradiating the metal powder with laser light to produce a sintered body.

(16)

The method according to aspect (15), wherein the laser light has a wavelength in a range of from 200 to 11000 nm.

(17)

A method for producing a surface-treated metal powder for laser sintering, comprising a step of subjecting a metal powder to a roughening treatment to obtain a roughening-treated metal powder.

(18)

The method according to aspect (17), wherein after the step of obtaining the roughening-treated metal powder, the method comprises a step of subjecting the roughening-treated metal powder to a sputtering treatment; a step of subjecting the roughening-treated metal powder to a hypochlorite treatment and a dilute sulfuric acid treatment; or a step of subjecting the roughening-treated metal powder to an electroless plating treatment.

(19)

A method for producing a laser sintered body, comprising a step of laser-sintering the surface-treated metal powder for laser sintering, produced by the method according to any one of aspects (17) to (18), by irradiating the metal powder with laser light to produce a sintered body.

(20)

A method for producing a surface-treated metal powder for laser sintering, comprising a step of oxidizing the metal powder in an acidic aqueous sulfuric acid solution having a pH of from 3 to 7.

(21)

The method for producing the surface-treated metal powder according to aspect (20), wherein the acidic aqueous sulfuric acid solution is at a temperature in a range of from 30 to 50° C.

(22)

The method for producing the surface-treated metal powder according to aspect (20) or (21), wherein the acidic aqueous sulfuric acid solution contains either a natural resin, a polysaccharide, or gelatin.

(23)

A method for producing a .surface-treated metal powder for laser sintering, comprising oxidizing the metal powder in hot water at a temperature of from 40 to 70° C.

(24)

The method for producing the surface-treated metal powder according to aspect (23), wherein the hot water contains either a natural resin, polysaccharide, or gelatin.

(25)

A method for producing a laser sintered body, comprising: a step of laser-sintering the surface-treated metal powder for laser sintering, produced by the method according to any one of aspects (20) to (24), by irradiating the metal powder with laser light to produce a sintered body.

### Advantageous Effects of Invention

According to the present invention, it is possible to obtain a metal powder having improved laser absorbability, which can be suitably used for metal AM.

### BRIEF DESCRIPTION OF DRAWINGS

FIG. 1 is an explanatory view showing a relationship between a hole formed by a laser and a height.

### DESCRIPTION OF THE PREFERRED EMBODIMENTS

Hereinafter, the present invention will be described in detail with reference to embodiments. The present invention is not limited to the specific embodiments described below.

### [Production of Surface-Treated Metal Powder]

A surface-treated metal powder according to the present invention can be produced by a method including a step of subjecting a metal powder to a roughening treatment to obtain a roughening-treated metal powder, In a preferred embodiment, after the step of obtaining the roughening-treated metal powder, the method can include a step of subjecting the roughening-treated metal powder to a sputtering treatment; a step of subjecting the roughening-treated metal powder to a hypochlorite treatment and a sulfuric acid treatment; or a step of subjecting the roughening-treated metal powder to an electroless plating treatment.

Alternatively, the surface-treated metal powder according to the present invention can be produced by a method including oxidizing a metal powder in an acidic aqueous sulfuric acid solution having a pH of from 3 to 7. Alternatively, the surface-treated metal powder according to the present invention can be produced by a method including oxidizing a metal powder in hot water at a temperature of from 40 to 70° C.

### [Metal of Metal Powder to be Surface-Treated]

A metal of the metal powder to be surface-treated is not particularly limited as long as it is a metal, and examples of the metal include Cu, Ni, Co, Ti, Cr, Al, V, Mo, Fe, Si, Mg, Sn, Zn, Ag, Au, Pd, Pt, Os, Ir, Re, Ru and alloys thereof. Examples of the metal of the metal powder to be surface-treated includes copper, copper alloys, aluminum, aluminum alloys, iron, iron alloys, nickel, nickel alloys, gold, gold alloys, silver, silver alloys, platinum group, platinum group alloys, chromium, chromium alloys, magnesium, magnesium alloys, tungsten, tungsten alloys, molybdenum, molybdenum alloys, lead, lead alloys, tantalum, tantalum alloys, tin, tin alloys, indium, indium alloys, zinc, zinc alloys and the like. Other known metal materials may be used. Metal materials standardized by JIS standards, CDA or the like may be used. In terms of lower cost and relatively higher conductivity, copper or the copper alloys are preferable.

Typically, copper includes copper having a purity of 95% or more, and more preferably 99.90% or more, as defined in JIS H0500 and JIS H3100, such as phosphorus deoxidation copper (JIS H3100, alloy Nos. C1201, C1220, C1221), oxygen free copper (JIS H3100, alloy No. C1020) and tough pitch copper (JIS H3100, alloy No. C1100), and an electrolytic copper foil. It may be copper or a copper alloy containing a least one selected from Sn, Ag, Au, Co, Cr, Fe, In, Ni, P, Si, Te, Ti, Zn, B, Mn and Zr in a total amount of from 0.001 to 4.0% by mass.

Examples of the copper alloy includes a Cu—Sn—Zn alloy, a Cu—Zn alloy, a Cu—Ni—Sn alloy, a Cu—Ti alloy, a Cu—Fe alloy, a Cu—Ni—Si alloy, a Cu—Ag alloy and the like, Further, the copper alloy can include a Cu-8Sn-0.5Zn, a Cu-3Sn-0.05P and the like.

Further examples of the copper alloy include phosphor bronze, Corson alloy, gunmetal, brass, nickel silver and other copper alloy. Furthermore, the copper or copper alloy that can be used in the present invention includes copper or copper alloys as defined in JIS H 3100 to JIS H 3510; JIS H 5120; JIS H 5121; JIS C 2520 to JIS C 2801; and JIS E 2101 to JIS E 2102. As used herein, the JIS standards listed for indicating the standard of the metal means the JIS standard of the 2001 version, unless otherwise specified.

The phosphor bronze typically refers to a copper alloy containing Sn as a main component and P with a smaller mass than Sn. As an example, the phosphor bronze contains from 3.5 to 11% by mass of Sn, and from 0.03 to 0.35% by mass of P, the balance being copper and inevitable impurities. The phosphor bronze may contain an element(s) such as Ni and Zn in a total amount of 10.0% by mass or less.

The Corson alloy typically refers to a copper alloy containing added elements that forms a compound with Si (for example, one or more of Ni, Co, and Cr) and precipitates as second phase particles in a parent phase. As an example, the Corson alloy has a composition containing from 0.5 to 4.0% by mass of Ni and from 0.1 to 1.3% by mass of Si, the balance being copper and inevitable impurities. As another example, the Corson alloy has a composition containing from 0.5 to 4.0% by mass of Ni, from 0.1 to 1.3% by mass of Si, and from 0.03 to 0.5% by mass of Cr, the balance being copper and inevitable Impurities. As still another example, the Corson alloy has a composition containing from 0.5 to 4.0% by mass of Ni, from 0.1 to 1.3% by mass of Si, from 0.5 to 2.5% by mass of Co, the balance being copper and inevitable impurities. As still another example, the Corson alloy has a composition containing from 0.5 to 4,0% by mass of Ni, from 0.1 to 1.3% by mass of Si, from 0.5 to 2.5% by mass of Co, and from 0.03 to 0.5% by mass of Cr, the balance being copper and inevitable impurities, As still another example, the Corson alloy has a composition containing from 0.2 to 1.3% by mass of Si and from 0.5 to 2.5% by mass of Co, the balance being copper and inevitable impurities. The Corson alloy may optionally contain other elements (for example, Mg, Sn, B, Ti, Mn, Ag, P, Zn, As, Sb, Be, Zr, Al and Fe). These other elements are generally added in a total amount of up to about 5.0% by mass. For example, as still another example, the Corson alloy has a composition containing from 0.5 to 4.0% by mass of Ni, from 0.1 to 1.3% by mass of Si, from 0.01 to 2.0% by mass of Sn, and from 0.01 to 2.0% by mass of Zn, the balance being copper and inevitable impurities.

As used herein, the gunmetal refers to an alloy of copper and zinc, which contains from 1 to 20% of zinc, and more preferably from 1 to 10% by mass of zinc. Further, the gunmetal may contain from 0.1 to 1.0% by mass of tin.

As used herein, the brass refers to an alloy of copper and zinc, particularly a copper alloy containing 20% or more of zinc. The upper limit of zinc is not particularly limited, but it may be 60% by mass or less, and preferably 45% by mass or less, or 40% by mass or less.

As used herein, the nickel silver refers to a copper alloy mainly based on copper, which contains from 60 to 75% by mass of copper, from 8.5 to 19.5% by mass of nickel and from 10 to 30% by mass of zinc.

As used herein, the other copper alloy refers to a copper alloy containing one or more of Zn, Sn, Ni, Mg, Fe, Si, P, Co, Mn, Zr, Ag, B, Cr and Ti in a total amount of 8.0% or less, the balance being inevitable impurities and copper.

Examples of the aluminum and aluminum alloy that can be used include those containing 40% by mass or more of Al, or 80% by mass or more of Al, or 99% by mass or more of Al. For example, aluminum and aluminum alloy defined in JIS H 4000 to JIS H 4180; JIS H 5202; JIS H 5303; or JIS Z 3232 to JIS Z 3263 can be used. For example, aluminum containing 99.00% by mass or more of Al or an alloy thereof or the like represented by Al alloy Nos. 1085, 1080, 1070, 1050, 1100, 1200, 1N00 and 1N30, as defined in JIS H 4000 can be used.

Examples of the nickel and nickel alloy that can be used include those containing 40% by mass or more of Ni, or 80% by mass or more of Ni, or 99.0% by mass or more of Ni. For example, nickel or a nickel alloy defined in JIS H 4541 to JIS H 4554; JIS H 5701; or JIS G 7604 to JIS G 7605; or JIS C 2531 can be used. Further, for example, nickel having 99.0% by mass or more of Ni and an alloy thereof or the like represented by alloy Nos. NW 2200 and NW 2201 defined in JIS H 4551 can be used.

Examples of the iron alloy that can be used include soft steel, carbon steel, iron-nickel alloy, steel, stainless steel and the like. For example, iron or an iron alloy defined in JIS G 3101 to JIS G 7603; JIS C 2502 to JIS C 8380; JIS A 5504 to JIS A 6514; or JIS E 1101 to JIS E 5402-1 can be used. The soft steel that can be used include that contains 0.15% by mass or less of carbon, and soft steel defined in JIS G 3141. The iron-nickel alloy contains from 35 to 85% by mass of Ni, the balance being Fe and inevitable impurities. Specifically, an iron-nickel alloy defined in JIS C 2531 or the like can be used.

Examples of the zinc and zinc alloy that can be used include those containing 40% by mass or more of Zn, or 80% by mass or more Zn, or 99.0% by mass or more of Zn. For example, zinc or a zinc alloy defined in JIS H 2107 to JIS H 5301 can be used.

Examples of the lead and lead alloy that can be used include those containing 40% by mass or more of Pb, or 80% by mass or more of Pb, or 99.0% by mass or more of Pb. For example, lead or a lead alloy defined in JIS H 4301 to JIS H 4312 or JIS H 5601 can be used.

Examples of the magnesium and magnesium alloy that can be used include those containing 40% by mass or more of Mg, or 80% by mass or more Mg, or 99.0% by mass or more of Mg. For example, magnesium and a magnesium alloy defined in JIS H 4201 to JIS H 4204, JIS H 5203 to JIS H 5303, or JIS H 6125 can be used.

Examples of the tungsten and tungsten alloy that can be used include those containing 40% by mass or more of W, or 80% by mass or more of W, or 99.0% or more of W. For example, tungsten and a tungsten alloy defined in JIS H 4463 can be used.

Examples of the molybdenum and molybdenum alloy that can be used include those containing 40% or more of Mo, or 80% by mass or more of Mo, or 99.0% by mass or more of Mo.

Examples of the tantalum and tantalum alloy that can be used include those containing 40% by mass or more of Ta, or 80% by mass or more of Ta, or 99.0% by mass or more of Ta. For example, tantalum and tantalum alloy defined in JIS H 4701 can be used.

Examples of the tin and tin alloy that can be used include those containing 40% by mass or more of Sn, or 80% by mass or more of Sn, or 99.0% by mass or more of Sn. For example, tin and a tin alloy defined in JIS H 5401 can be used.

Examples of the indium and indium alloy that can be used include those containing 40% by mass or more of In, or 80% by mass or more of In, or 99.0% by mass or more of In.

Examples of the chromium and chromiu alloy that can be used include those containing 40% by mass or more of Cr, or 80% by mass or more of Cr, or 99.0%, by mass or more of Cr.

Examples of the silver and silver alloy that can be used include those containing 40% by mass or more of Ag, or 80% by mass or more of Ag, or 99.0% by mass or more of Ag.

Examples of the gold and gold alloy that can be used include those containing 40% by mass or more of Au, or 80% by mass or more of Au, or 99.0% by mass or more of Au.

The platinum group is a generic term for ruthenium, rhodium, palladium, osmium, iridium and platinum. Examples of the platinum group and platinum group alloy that can be used include those containing 40% by mass or more, or 80% by mass or more, or 99.0% by mass or more of at least one element selected from the element group consisting of Pt, Os, Ru, Pd, Ir and Rh, for example.

### Metal Powder to be Surface-Treated

Metal powder prepared by a known means can be used as a metal powder to be surface-treated. For example, metal powders produced by a method, for example, using an atomization method such as a gas atomization method and a plasma atomization method, or a chemical reaction such as an electrolytic method and a disproportionation reaction can be used.

### D50 of Metal Powder to be Surface-Treatment

In a preferred embodiment, the metal powder to be surface-treated can have, for example, D50 of 200 μm or less, 100 μm or less, 50 μm or less, and for example, D50 in a range of from 0.1 to 200 μm, from 1 to 200 μm, or from 10 to 200 μm.

### Roughening Treatment

The roughening treatment performed on the metal powder can be carried out by a known means, including, as a suitable roughening treatment, a roughening treatment with a dilute nitric acid solution, a roughening treatment with an aqueous dilute sulfuric acid/hydrogen peroxide solution.

The roughening treatment with the dilute nitric acid solution can be carried out, for example, by immersing the metal powder in an aqueous nitric acid having a concentration of from 1 to 20% by volume at a temperature of from 5 to 80° C. for 1 second to 120 seconds.

The roughening treatment with the aqueous dilute sulfuric acid/hydrogen peroxide solution can be carried out by, for example, immersing the metal powder in an aqueous solution containing from 10g/L to 200 g/L of sulfuric acid and from 10 g/L to 100 g/L of hydrogen peroxide at a temperature of from 5° C. to 80° C. for 10 seconds to 600 seconds.

### Sputtering Treatment

In a preferred embodiment, the sputtering treatment can be carried out after the roughening treatment. Alternatively, the sputtering treatment can be carried out on the metal powder without performing the roughening treatment. The sputtering treatment can be carried out under known conditions, for example, under conditions of output: DC 50 W and argon pressure: from 0.1 to 0.3 Pa.

A composition of a sputtering target used for the sputtering that can be used includes, for example, a composition containing one or more elements selected from the group consisting of Ni, Zn, P, W, Sn, Bi, Co, As, Mo, Fe, Cr, V, Ti, Mn, Mg, Si, In and Al. In a preferred embodiment, for example, it can be a composition of an alloy containing the following combination of elements: Zn—Ni, Co—Cu, Cu—Ni, Cu—Co—Ni, Cu—Ni—P, Co—Fe—Ni—Cu, and Ni—W.

### Electroless Plating Treatment

In a preferred embodiment, the electroless plating treatment can be performed after the roughening treatment. Alternatively, the electroless plating treatment can be performed on the metal powder without carrying out the roughening treatment. The electroless plating treatment can be carried out under known conditions, for example, under conditions of a pH of from 3 to 12, a temperature of from 70 to 95° C., and a plating time of from 1 to 7200 seconds. A plating solution used for the electroless plating treatment includes, for example, a plating solution containing Ni, Co, Pd, P, B, and W.

### Hypochlorite Treatment and Dilute Sulfuric Acid Treatment

In a preferred embodiment, the hypochlorite treatment and the dilute sulfuric acid treatment can be performed after the roughening treatment. Alternatively, the hypochlorite treatment and dilute sulfuric acid treatment can be performed on metal powder without carrying out the roughening treatment. The hypochlorite treatment and the dilute sulfuric acid treatment are carried out by performing the hypochlorite treatment followed by the dilute sulfuric acid treatment. The hypochlorite treatment can be carried out, for example, by immersing the metal powder in an aqueous solution containing sodium hypochlorite, sodium hydroxide and sodium phosphate at a temperature of from 50° C. to 100° C. for 0.1 minutes to 10 minutes. The dilute sulfuric acid treatment can be carried out, for example, by immersing the metal powder in an aqueous sulfuric acid solution having a concentration of from 1% by mass to 20% by mass at a temperature of from 5 to 60° C. for 0.1 minutes to 10 minutes.

### Oxidation in Acidic Aqueous Sulfuric Acid Solution

The surface-treated metal powder according to the present invention can be produced by a method including a step of oxidizing the metal powder in an acidic aqueous sulfuric acid solution having a pH of from 3 to 7. Preferably, the metal powder can be mixed in an acidic aqueous sulfuric acid solution with stirring or ultrasonic irradiation by a known means. The treatment in the acidic aqueous sulfuric acid solution can be carried out, for example, for 0.5 to 8 hours, alternatively for 2 to 4 hours. The temperature of the acidic aqueous sulfuric acid solution may be, for example, in a range of from 30 to 50° C., preferably in a range of from 35 to 45° C. The pH of acidic aqueous sulfuric acid solution can be adjusted by adding sulfuric acid to water. The pH range to be adjusted can be, for example, from pH 3 to pH 7, and preferably from pH 4 to pH 7. If the pH is below 3, a formed oxide layer may dissolve in the acid. In the present invention, this oxidation treatment forms a copper oxide layer which is not normally preferred as a conductor material.

In a preferred embodiment, either a natural resin, a polysaccharide or gelatin can be added to the acidic aqueous sulfuric acid solution. The natural resin includes, for example, gum arabic. The natural resin, the polysaccharide or the gelatin can be added such that the mass of it is, for example, from 0.1 to 10% by mass, and preferably from 0.5 to 2% by mass, based on the mass of the metal powder.

The metal powder oxidized with the acidic aqueous sulfuric acid solution can be separated from the slurry containing the acidic aqueous sulfuric acid solution by a known means and can be used for the subsequent treatment. If desired, the acid remaining on the surface of the metal, powder can be removed by means of water washing or the like after separating the metal powder from slurry containing the acidic aqueous sulfuric acid solution, and then used for subsequent treatment. The oxidized metal powder may be dried or crushed if desired. The drying can be carried out by a known means, for example at a temperature of from 60 to 80° C., for example, for 0.5 to 2 hours in nitrogen, air or the like.

### Oxidation in Hot Water

The surface-treated metal powder according to the present invention can be produced by a method including oxidizing the metal powder in hot water at a temperature of from 40 to 70° C., Preferably, the metal powder can be mixed in hot water with stirring or ultrasonic irradiation by a known means. The treatment in hot water can be carried out, for example, for 0.5 to 8 hours, alternatively for 2 to 4 hours. The temperature of the hot water can be, for example, a temperature in a range of from 40 to 70° C., and preferably in a range of from 55 to 65° C. It is not necessary to adjust a pH of the hot water if it is pH at the time when heated to steam temperature in the atmosphere, but it may be in a range of pH 6.0 to pH 7.0, for example. In the present invention, this oxidation treatment forms a copper oxide layer which is not normally preferred as a conductor material.

In a preferred embodiment, either a natural resin, a polysaccharide or gelatin can be added to the hot water. The natural resin includes, for example, gum arabic. The natural resin, the polysaccharide or the gelatin can be added such that the mass of it is, for example, from 0.1 to 10% by mass, and preferably from 0.5 to 2% by mass, based on the mass of the metal powder.

The metal powder oxidized with hot water can be separated from the slurry containing hot water by a known means and can be used for subsequent treatment. The oxidized metal powder may be dried or crushed if desired. The drying can be carried out by a known means, for example at a temperature of from 60 to 80° C., for example, for 0.5 to 2 hours in nitrogen, air or the like.

### Formation of Oxide Layer

In the present invention, a copper oxide layer which is not usually preferred as a conductor material is formed by the above oxidation treatment. This copper oxide layer may be formed by heating in the presence of oxygen, such as air atmosphere, in addition to the above-mentioned means.

### Color Properties of Surface-Treated Metal Powder

The surface-treated metal powder has the following color properties on its surface by the above treatment. As disclosed in Examples, the properties can be measured in accordance with JIS Z 8730 as follows. Color differences on the metal powder surface (ΔL (which is the same as ΔL*), Δa (which is the same as Δa*), Δb (which is the same as Δb*) and ΔE (which is the same as ΔE*ab)) and CIE lightness L*, color coordinate a* and color coordinate b* which are object colors for the metal powder were measured using, as a reference color, an object color of a white plate (when a light source is D65 and a field of view is 10 degrees, tristimulus values of a X₁₀Y₁₀Z₁₀ color system (JIS Z 8701 1999) of the white plate are X₁₀=80.7, Y₁₀=85.6, and Z₁₀=91.5, and an object color of the white plate in a L*a*b* color system is L*=94.14, a*=−0.90, b*=0.24). Here, ΔL refers to a difference between the CIE lightness L* of two object colors in the L*a*b* color system defined in JIS Z 8729 (2004). Further, Δa refers to a difference between the color coordinates a* of two object colors in the L*a*b* color system defined in JIS Z 8729 (2004), Furthermore, Δb refers a difference between the color coordinates b* of two object colors in the L*a*b* color system defined in JIS Z 8729 (2004). The color difference meter is calibrated by covering a measurement hole with the white plate and a light trap. Here, the color difference (ΔE) is a comprehensive index shown by using the L*a*b* color system taking into consideration black/white/red/green/yellow/blue, and represented by the following equation as ΔL: black-white, Δa: red-green, and Δb: yellow-blue. When the color difference of the object below the metal powder on the side opposite to the color difference meter has an effect, the thickness of the metal powder to be spread is preferably more than 1 mm.

ΔE=\sqrt{ΔL²+Δa²+Δb²} [Equation 1]

It should be noted that if the color difference meter is contaminated with the metal powder, for example, the metal powder is placed in a resin bag (a thickness of from 5 to 50 μm) such as transparent polyethylene, and the above color difference may be then measured over the resin bag. It is preferable that the thickness of the resin bag is smaller, for example, 50 μm or less, for example, 40 μm or less, for example, 30 μm or less, for example, 10 μm or less.

In a preferred embodiment, the lightness L* on the surface can be, for example, in a range of from 0 to 50, in a range of from 1 to 45, in a range of from 3 to 40, in a range of from 4 to 35, in a range of from 5 to 30, in a range of from 5 to 28, or in a range of from 6 to 25.

In a preferred embodiment, the color coordinate a* on the surface can be, for example, in a range of 20 or less, 17 or less, −15 or more and 15 or less, −10 or more and 10 or less, −9 or more and 9 or less, −8 or more and 8 or less, or −6 or more and 6 or less.

In a preferred embodiment, the color coordinate b* on the surface can be, for example, in a range of 20 or less, 17 or less, −15 or more and 15 or less, −10 or more and 10 or less, −9 or more and 9 or less, −8 or more and 8 or more, or −6 or more and 6 or less.

In the preferred embodiment, when the object color (lightness L*=94.14, color coordinate a*=−0.90, color coordinate b*=0.24) of the white plate is used as a reference, ΔEab on the surface can be, for example, in a range of 40 or more, 43 or more, 45 or more, 47 or more, 48 or more, 50 or more, 52 or more, 53 or more, 53 or more and 100 or less, or 55 or more and 98 or less. The upper limit of ΔEab is not particularly limited, but it is typically 100 or less, and more typically 98 or less, and more typically 95 or less, and more typically 94 or less.

In the preferred embodiment, when the object color (lightness L*=94.14, color coordinate a*=−0.90, color coordinate b*=0.24) of the white plate is used as a reference, the color difference ΔL on the surface can be, for example, in a range of −35 or less, −38 or less, −40 or less, −42 or less, −45 or less, −48 or less, −50 or less, −53 or less, −100 or more and −53 or less, or −98 or more and −52 or less. The lower limit of the color difference AL on the surface is not particularly limited, but it is typically −100 or more, and more typically −98 or more, and more typically −95 or more.

In the preferred embodiment, when the object color (lightness L*=94.14, color coordinate a*=−0.90, color coordinate b*=0.24) of the white plate is used as a reference, the color difference Aa on the surface can be, for example, in a range of 20 or less, 17 or less, −15 or more and 15 or less, −10 or more and 10 or less, −9 or more and 9 or less, −8 or more and 8 or less, or −6 or more and 6 or less.

In the preferred embodiment, when the object color (lightness L*=94.14, color coordinate a*=−0.90, color coordinate b*=0.24) of the white plate is used as a reference, the color difference Ab on the surface can be, for example, in a range of 20 or less, 17 or less, −15 or more and 15 or less, −10 or more and 10 or less, −9 or more and 9 or less, −8 or more and 8 or less, or −6 or more and 6 or less.

### Laser Absorbability

As a result of having the color properties as described above, the surface-treated metal powder according to the present invention has good laser absorbability. The laser absorbability can be evaluated by the means disclosed in Examples. The surface-treated metal powder according to the present invention can be laser-sintered by irradiating the metal powder with laser light, thereby suitably producing a sintered body.

### Laser Wavelength

In a preferred embodiment, the wavelength of the laser light can be one or two in a range of from 200 to 11000 nm, preferably in a range of from 250 to 10600 nm, preferably in a range of from 350 to 1100 nm, preferably in a range of from 400 to 1070 nm, preferably in a range of from 400 to 500 nm, and in a range of from 1000 to 1070 nm.

### D50 of Surface-Treated Metal Powder

In a preferred embodiment, D50 of the surface-treated metal powder reflects the D50 of the metal powder to be surface-treated, and it can be, for example, D50 in a range of 200 μm or less, 100 μm or less, 50 μm or less, for example, in a range of from 0.1 to 200 μm, from 1 to 200 μm and from 10 to 200 μm.

### EXAMPLES

Hereinafter, the present invention will be described in detail with Examples. The present invention is not limited to Examples illustrated below.

### Example 1: Inventive Examples 1 to 7, 9, and Comparative Example 4

Atomized powder (metal powder) having a predetermined size was immersed in 10 vol % diluted nitric acid at a predetermined temperature for a predetermined time, and then recovered by suction filtration, and dried at 70° C. for 1 hour in nitrogen. Components of the metal powder are as shown in Table 1. Thus, the roughening treatment was performed on the metal powder.

It should be noted that during the immersion, stirring was carried out with a stirrer (rotation speed of stirrer: 120 rpm). The stirring was carried out in all of the following immersion operations.

The resulting powder was subjected to the barrel sputtering method described in Japanese Patent No. 3620842 B to form each surface-treated layer with a thickness of 10 nm on the surface of the powder (surface treatment 1). Surface treatment 1 was performed on the metal powder thus roughening-treated to obtain surface-treated powders (surface-treated metal powders) of Inventive Examples 1 to 7, 9 and Comparative Example 4.

A composition of a target used in sputtering was the same composition as that of each surface-treated layer as shown in Table 1. Further, in “Surface Treatment 1” in Table 1, the numerals indicate wt % of each element in the surface-treated layer, and parts showing only the element having no numerical value represent a metal alone containing only the shown element, excluding impurities. The concentration of the element with no numerical value was 99.5 wt % or more. The optical properties of the powder (surface-treated metal powder) were then measured as described below.

### Measurement of Color Differences (L*, a*, b*, ΔL, Δa, Δb, ΔE) of Surface-Treated Metal Powder Surface

Each surface-treated powder (surface-treated metal powder) thus obtained was spread over a transparent glass plate (Petri dish) with a thickness of 1 mm or more in a sufficiently wide range to cover the measurement hole of the color difference meter, and each value was measured using a color difference meter MiniScan XE Plus from Hunter Lab in accordance with JIS Z 8730 as follows. The color differences on the metal powder surface (ΔL (which is the same as ΔL*), Δa (which is the same as Δa*), Δb (which is the same as Δb*) and ΔE (which is the same as ΔE*ab)) and CIE lightness L*, color coordinate a* and color coordinate b* which are object colors for the metal powder were measured using, as a reference color, an object color of a white plate (when a light source is D65 and a field of view is 10 degrees, tristimulus values of a X₁₀Y₁₀Z₁₀ color system (JIS Z 8701 1999) of the white plate are X₁₀=80.7, Y₁₀=85.6, and Z₁₀=91.5, and an object color of the white plate in a L*a*b* color system is L*=94.14, a*=−0.90, b*=0.24). Here, ΔL refers to a difference between the CIE lightness L* of two object colors in the L*a*b* color system defined in JIS Z 8729 (2004). Further, Δa refers to a difference between the color coordinates a* of two object colors in the L*a*b* color system defined in JIS Z 8729 (2004). Furthermore, Δb refers a difference between the color coordinates b* of two object colors in the L*a*b* color system defined in JIS Z 8729 (2004). The color difference meter described above is calibrated by covering a measurement hole with the white plate and a light trap. Here, the color difference (ΔE) is a comprehensive index shown by using the L*a*b* color system taking into consideration black/white/red/green/yellow/blue, and represented by the following equation as ΔL: black and white, Δa: red green, and Δb: yellow blue. When the color difference of the object below the metal powder on the side opposite to the color difference meter has an effect, the thickness of spreading the metal powder is preferably more than 1 mm.

ΔE=\sqrt{ΔL²+Δa²+Δb²} [Equation 2]

### Evaluation of Laser Absorbability

The laser absorbability was evaluated as follows.

Each disk-shaped sample having a diameter of 10 mm and a thickness of from 0.5 to 5 mm were formed from each metal powder using a powder forming machine (Labopress LP-200) and a powder forming mold (Labodies) from Labonexst Co., Ltd.

The laser absorbability was then evaluated using a YAG laser processing machine.

### Laser Irradiation Condition

### Laser Wavelength; 1064 nm;

### Beam Diameter of Laser: 50 μm;

### Output: 400 W;

### Pulse Energy: 3 mJ;

### Pulse Width: 7.5 μs;

### Processing Method: Burst Mode; and

Number of shots: 1 shot.

After the laser irradiation, a depth of a hole generated in each sample was measured with a laser microscope. The depth of the hole was measured as follows.

Using a laser microscope (LEXT OLS 4000 from Olympus Corporation), measurement was performed on the surface of each sample having the above hole, under the following measurement conditions.

### Measurement Condition

### Cutoff: None;

### Reference Length: 257.9 μm;

### Reference Area: 66524 μm²; and

Measurement Environment Temperature: from 23 to 25° C.

The following settings were made for the laser microscope LEXT OLS 4000 from Olympus Corporation. With regard to the setting of “Correct Line Data”, the (correction processing) button on the measurement panel was clicked and the “Tilt Correction” was selected as a type of correction processing. Further, for the setting of “Remove Noise of Line Data”, the (Noise Removal) button on the measurement panel was clicked and “All Range” was selected as a range to be removed.

3D images were created with the laser microscope LEXT OLS 4000 from Olympus Corporation using analysis software (analyzing software ver. 2.2.4.1 attached to the laser microscope LEXT OLS 4000 from Olympus Corporation) used for analyzing the measurement data obtained as described above.

For each 3D image, a 3D image having a position in an X axis direction (μm), a position in a Y axis direction (μm), and a Z axis: height (μm) based on the measurement data of the heights (μm) at each of the position in the X axis direction (μm) and the position in Y axis direction (μm) obtained by measuring each sample surface with the laser microscope.

Then, in the direction parallel to the X axis direction, the depth of the hole at the position where the depth of the hole became deepest was determined to be the depth of the hole of the sample;

It should be noted that the depth of the hole was defined as follows:

The highest position 1 and the highest position 2 which are present on both sides of the lowest position of the hole were specified.

Then, height hi and height h2 are calculated by the following equations:

height h1=height of the highest position 1−height of the lowest position; and

height h2=height of the highest position 2−height of the lowest position.

Then, an arithmetic mean value of the height h1 and the height h2 was determined to be the depth of the hole.

The depth of the hole as described below was measured along the Y axis direction, and a depth value of the hole having the greatest value was determined to be a depth of hole for the hole.

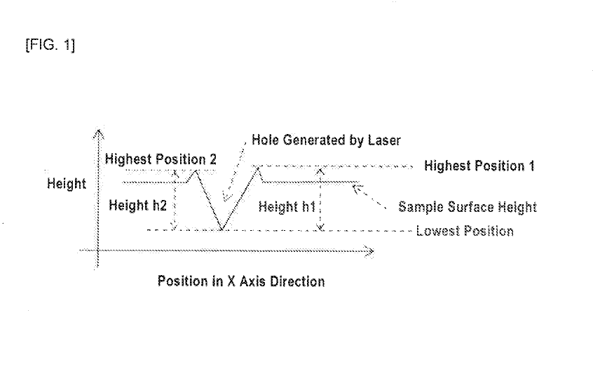

Three disk-shaped samples were prepared for each metal powder, and the arithmetic mean value of the depths of the holes of the three samples was determined to be the depth value of the hole generated in the sample. FIG. 1 shows an explanatory view of a relationship between the hole generated by the laser and the height.

After measuring the depth of the hole as described above, the presence or absence of sintering of the metal powder near the hole generated by the laser was confirmed in a cross section which was parallel to the thickness direction of the disk-shaped sample, was perpendicular to the surface of the disk-shaped sample and was across the widest portion of the hole generated by the laser. When sintering was generated, the sum of a thickness at which the sintering occurs from a portion with the lowest height of the hole generated by the laser (the thickness in the direction parallel to the thickness direction of the disk-shaped sample) and the depth of the hole was determined to be the depth of the hole. For Inventive Examples 1 to 17, sintering of the metal powder was observed. For Comparative Examples 1 to 5, no sintering of metal powder was observed.

The laser absorbability was then determined as follows:

### Laser Absorbability

x: depth of hole of less than 55 μm;
∘: depth of hole of 55 μm or more and less than 60 μm;
∘∘: depth of hole of 60 μm or more and less than 70 μm;
⊚: depth of hole of 70 μm or more and less than 80 μm; and
⊚⊚: depth of hole of 80 μm or more.

### Evaluation of D50

D50s of the metal powder before the surface treatment and the surface-treated powder (surface-treated metal powder) thus obtained were measured using a laser diffraction type particle size distribution measuring apparatus (SALD-2100 from Shimadzu Corporation). The above D50 means a particle diameter D50 (median diameter) of the metal powder.

It should be noted that D50s of the metal powder before the surface treatment and the surface-treated powder (surface-treated metal powder) obtained were the same value.

### Example 8

Copper powder prepared by an electrolytic method was subjected to the roughening treatment, and a surface-treated layer of 10 nm was then formed by the barrel sputtering method (surface treatment 1) to obtain a surface-treated powder (surface-treated metal powder), in the same method as that of Inventive Example 1.

### Inventive Examples 10, 11, 16, and Comparative Examples 3, 5

Atomized powder having a predetermined size was subjected to the above barrel sputtering method (surface treatment 1) without the roughening treatment to form a surface-treated layer of 10 nm, thereby obtaining a surface-treated powder (surface-treated metal powder).

### Example 12

The roughening treatment was carried out by immersing atomized powder (copper powder) in a mixed aqueous solution of sulfuric acid and hydrogen peroxide at a predetermined concentration under certain conditions, and the powder was then recovered by suction filtration, and a surface-treated layer of 10 nm was formed by the barrel sputtering method (surface treatment 1) to obtain a surface-treated powder (surface-treated metal powder).

### Example 13

Atomized copper powder was subjected to the roughening treatment by immersing the powder in a mixed aqueous solution of sulfuric acid and hydrogen peroxide at a predetermined concentration for certain conditions, and the surface treatment 1 was carried out by recovering the powder by suction filtration, immersing it in an aqueous sodium hypochlorite solution, recovering the powder by suction filtration, and further immersing the powder in dilute sulfuric acid. The surface-treated powder (surface-treated metal powder) was then obtained by suction filtration. Thus, the roughening treatment and the surface treatment 1 (a two-step immersion treatment with an aqueous sodium hypochlorite solution and a dilute sulfuric acid) were carried out.

### Example 14

Atomized copper powder was subjected to the roughening treatment by immersing the powder in an aqueous solution containing sulfuric acid, hydrogen peroxide, triazole, and phosphorous acid, and then recovered by suction filtration to obtain a surface-treated powder (surface-treated metal powder).

### Example 15

Copper powder prepared by the atomization method was subjected to the roughening treatment in the same method as that of Example 1, and then subjected to electroless plating under the following conditions (surface treatment 1) to obtain a surface-treated powder (surface-treated metal powder).

Electroless Ni—P plating

| | |
|---|---|
| Plating Solution Composition | |
| Nickel Sulfate | 30 g/L |
| Sodium Hypophosphite | 10 g/L |
| Sodium Acetate | 10 g/L |
| Balance being water | |
| pH | 5 |
| Temperature | 90° C. |
| Immersion Time | 1 minute |
| P content | 8 wt % |

Thickness of Ni—P plating: 250 nm.

In the present specification, with regard to a surface treatment solution such as a plating solution, the balance of any solution in which the balance is not described is water, unless otherwise indicated. That is, unless otherwise indicated, the surface treatment solution is an aqueous solution.

### Example 17

Copper powder prepared by the electrolysis method was subjected to the roughening treatment in the same method as that of Example 1, and then subjected to electroless plating under the following conditions (surface treatment 1) to obtain a surface-treated powder (surface-treated metal powder).

Electroless Ni—W—P plating

| | |
|---|---|
| Nickel Sulfate | 20 g/L, |
| Sodium Tungstate | 50 g/L, |
| Sodium Hypophosphite | 20 g/L, |
| Sodium Citrate | 30 g/L, |
| pH | 10, |
| Temperature | 90° C., |

Concentration of Each Element in Surface-Treated Layer

| | |
|---|---|
| Ni concentration | 80 wt%, |
| W concentration | 12 wt%, and |
| P concentration | 8 wt%. |

### Comparative Examples 1 and 2

Powders each having a predetermined composition and size were prepared by the atomization method.

### Example 18

100 g of atomized copper powder was added to 1 L of pure water, the pH was adjusted with dilute sulfuric acid (40° C., pH 4.5), stirred for 3 hours, recovered by suction filtration, dried at 70° C. for 1 hour in nitrogen and then crushed.

### Example 19

100 g of atomized copper powder and 1 g of gum arabic were added to 1 L of pure water, the pH was adjusted with dilute sulfuric acid (40° C., pH 4.5), stirred for 3 hours, recovered by suction filtration, dried at 70° C. for 1 hour in nitrogen, and then crushed.

### Example 20

100 g of atomized copper powder was added to 1 L of pure water, heated to 60° C. and stirred for 3 hours. It was recovered by suction filtration, dried at 70° C. for 1 hour in nitrogen, and then crushed.

### Example 21

100 g of atomized copper powder and 1 g of gum arabic were added to 1 L of pure water, heated to 60° C. and stirred for 3 hours. It was recovered by suction filtration, dried at 70° C. for 1 hour in nitrogen, and then crushed.

### Results

The conditions and results of the above Inventive Examples and Comparative Examples are summarized in Table 1 below. In Table 1, D50 represents the D50 [μm] of the metal powder before the surface treatment. The value of D50 [μm] of the metal powder after the surface treatment was the same value as the D50 [μm] of the metal powder before the surface treatment.

TABLE 1

| Example | | | | | | | | | | | | | | |
|---|---|---|---|---|---|---|---|---|---|---|---|---|---|---|
| (Ex.)/ | Method | | | | | | | | | | | | | |
| Compar- | for | Metal | | | Surface | | | | | | | | | |
| ative | Producing | Powder | | | Treat- | | | | | | | | | Laser |
| Example | Metal | Compo- | Roughening | Surface | ment 1 | | | | | | | | | Absorb- |
| (Comp.) | Powder | nent | Treatment | Treatment 1 | Method | D50 | L* | a* | b* | ΔEab* | ΔL | Δa | Δb | ability |
| Ex. 1 | Atomizing | Cu | Immersed in | 63Zn-37Ni | Sput- | 40 | 11.3 | 1.1 | 2.3 | 82.9 | -82.8 | 2.0 | 2.1 | ⊚⊚ |
| | | | 10 vol % | | tering | | | | | | | | | |
| | | | nitric acid aq. | | | | | | | | | | | |
| | | | solution at 50° C. | | | | | | | | | | | |
| | | | for 25 s | | | | | | | | | | | |
| Ex. 2 | Atomizing | Cu | Immersed in | 93Co-7Cu | Sput- | 40 | 31.4 | 3.3 | 4.5 | 63.0 | -62.7 | 4.2 | 4.3 | ○○ |
| | | | 10 vol % | | tering | | | | | | | | | |
| | | | nitric acid aq. | | | | | | | | | | | |
| | | | solution at 25° C. | | | | | | | | | | | |
| | | | for 10 s | | | | | | | | | | | |
| Ex. 3 | Atomizing | Cu | Immersed in | 50Cu-50Ni | Sput- | 40 | 25.0 | 6.1 | 7.2 | 69.8 | -69.1 | 7.0 | 7.0 | ⊚ |
| | | | 10 vol % | | tering | | | | | | | | | |
| | | | nitric acid aq. | | | | | | | | | | | |
| | | | solution at 25° C. | | | | | | | | | | | |
| | | | for 10 s | | | | | | | | | | | |
| Ex. 4 | Atomizing | Cu | Immersed in | Cu/87Cu- | Sput- | 40 | 40.7 | 10.5 | 12.3 | 56.0 | -53.4 | 11.4 | 12.1 | ○ |
| | | | 10 vol % | 10.4Co-2.6Ni | tering | | | | | | | | | |
| | | | nitric acid aq. | | | | | | | | | | | |
| | | | solution at 25° C. | | | | | | | | | | | |
| | | | for 10 s | | | | | | | | | | | |
| Ex. 5 | Atomizing | Ni | Immersed in | 97Cu- | Sput- | 40 | 19.3 | 4.3 | 6.1 | 75.2 | -74.8 | 5.2 | 5.9 | ⊚⊚ |
| | | | 10 vol% | 2.5Ni-0.5P | tering | | | | | | | | | |
| | | | nitric acid aq. | | | | | | | | | | | |
| | | | Solution at 25° C. | | | | | | | | | | | |
| | | | for 20 s | | | | | | | | | | | |
| Ex. 6 | Atomizing | Cu | Immersed in | 87Cu-10.4Co- | Sput- | 40 | 21.8 | 3.1 | 2.9 | 72.5 | -72.3 | 4.0 | 2.7 | ⊚ |
| | | | 10 vol % | 2.6Ni | tering | | | | | | | | | |
| | | | nitric acid aq. | | | | | | | | | | | |
| | | | solution at 25° C. | | | | | | | | | | | |
| | | | for 10 s | | | | | | | | | | | |
| Ex. 7 | Atomizing | Cu-8Sn- | Immersed in | 87Cu-10.4Co- | Sput- | 20 | 19.5 | 2.9 | 2.2 | 74.8 | -74.6 | 3.8 | 2.0 | ⊚⊚ |
| | | 0.5Zn | 10 vol % | 2.6Ni | tering | | | | | | | | | |
| | | | nitric acid aq. | | | | | | | | | | | |
| | | | solution at 25° C. | | | | | | | | | | | |
| | | | for 10 s | | | | | | | | | | | |
| Ex. 8 | Electrolytic | Cu | Immersed in | 87Cu-10.4Co- | Sput- | 15 | 15.8 | 3.2 | 4.9 | 78.6 | -78.3 | 4.1 | 4.7 | ⊚⊚ |
| | | | 10 vol % | 2.6Ni | tering | | | | | | | | | |
| | | | nitric acid aq. | | | | | | | | | | | |
| | | | solution at 25° C. | | | | | | | | | | | |
| | | | for 10 s | | | | | | | | | | | |
| Ex. 9 | Atomizing | Cu | Immersed in | Cu/87Cu- | Sput- | 40 | 48.3 | 14.9 | 16.9 | 51.3 | -45.8 | 15.8 | 16.7 | ○ |
| | | | 10 vol % | 10.4Co-2.6Ni | tering | | | | | | | | | |
| | | | nitric acid aq. | | | | | | | | | | | |
| | | | solution at 25° C. | | | | | | | | | | | |
| | | | for 2 s | | | | | | | | | | | |
| Ex. 10 | Atomizing | Co | — | 59Zn-4.1Ni | Sput- | 40 | 25.9 | 5.3 | 4.2 | 68.6 | -68.2 | 6.2 | 4.0 | ○○ |
| | | | | | tering | | | | | | | | | |
| Ex. 11 | Atomizing | Cu | — | 72.8Co-26.3Fe- | Sput- | 30 | 9.7 | 2.1 | 0.5 | 84.5 | -84.4 | 3.0 | 0.3 | ⊚⊚ |
| | | | | 0.7Ni-0.2Cu | tering | | | | | | | | | |
| Ex. 12 | Atomizing | Cu | Immersed in aq. | 99.9Ni-0.1W | Sput- | 30 | 35 | 7.2 | 6.1 | 60.0 | -59.1 | 8.1 | 5.9 | ○○ |
| | | | solution of | | tering | | | | | | | | | |
| | | | 100 g/l sulfuric | | | | | | | | | | | |
| | | | acid and | | | | | | | | | | | |
| | | | 50 g/l of | | | | | | | | | | | |
| | | | hydrogen | | | | | | | | | | | |
| | | | peroxide | | | | | | | | | | | |
| | | | at 30° C. for 1 min | | | | | | | | | | | |
| Ex. 13 | Atomizing | Cu | Immersed in aq. | Immersed in | Immer- | 30 | 15.2 | 5.1 | 4.2 | 79.3 | -78.9 | 6.0 | 4.0 | ⊚⊚ |
| | | | solution of | aq. Solution | sion | | | | | | | | | |
| | | | 100 g/l sulfuric | of 31 g/L | | | | | | | | | | |
| | | | acid and | sodium | | | | | | | | | | |
| | | | 50 g/l of | hypochlorile, | | | | | | | | | | |
| | | | hydrogen | 15 g/L sodium | | | | | | | | | | |
| | | | peroxide | hydroxide, | | | | | | | | | | |
| | | | at 30° C. for | 15 g/L sodium | | | | | | | | | | |
| | | | 1 min | phosphate at. | | | | | | | | | | |
| | | | | 90° C. for | | | | | | | | | | |
| | | | | 2 min, then | | | | | | | | | | |
| | | | | immersed in 10 | | | | | | | | | | |
| | | | | wt % sulfuric | | | | | | | | | | |
| | | | | acid | | | | | | | | | | |
| | | | | aq. solution | | | | | | | | | | |
| | | | | at 25° C. | | | | | | | | | | |
| | | | | for 2 min. | | | | | | | | | | |
| Ex. 14 | Atomizing | Cu | Immersed in | — | — | 60 | 39.6 | 21.2 | 20.1 | 62.1 | -54.5 | 22.1 | 19.9 | ○○ |
| | | | 160 g/L | | | | | | | | | | | |
| | | | sulfuric acid, | | | | | | | | | | | |
| | | | 100 g/L hydrogen | | | | | | | | | | | |
| | | | peroxide, 2 g/L | | | | | | | | | | | |
| | | | tolyltriazole, | | | | | | | | | | | |
| | | | 10 g/L phosphorous | | | | | | | | | | | |
| | | | acid, | | | | | | | | | | | |
| | | | balance water at | | | | | | | | | | | |
| | | | 30° C. for 1 min. | | | | | | | | | | | |
| Ex. 15 | Atomizing | Cu | Immersed in 10 | 92-Ni-8P | Electro- | 15 | 12.4 | 2.3 | 4.2 | 81.9 | -81.7 | 3.2 | 4.0 | ⊚⊚ |
| | | | vol % nitric acid aq. | | less | | | | | | | | | |
| | | | solution at 25° C. | | Plating | | | | | | | | | |
| | | | for 20 s | | | | | | | | | | | |
| Ex. 16 | Atomizing | Cu | — | 63Zn-37Ni | Sput- | 40 | 20.1 | 3.6 | 4.8 | 74.3 | -74.0 | 4.5 | 4.6 | ⊚ |
| | | | | | tering | | | | | | | | | |
| Ex. 17 | Atomizing | Cu | Immersed in 10 | 80-Ni-12W-8P | Electro- | 40 | 11.3 | 2.1 | 3 | 82.9 | -82.8 | 3.0 | 2.8 | ⊚⊚ |
| | | | vol % nitric acid aq. | | less | | | | | | | | | |
| | | | solution at 25° C. | | Plating | | | | | | | | | |
| | | | for 20 s | | | | | | | | | | | |
| Ex. 18 | Atomizing | Cu | — | Heated in 40° C. | — | 40 | 24.3 | 5.8 | 7.1 | 70.5 | -69.8 | 6.7 | 6.9 | ○○ |
| | | | | hot water | | | | | | | | | | |
| | | | | for 3 h (pH 4.5) | | | | | | | | | | |
| Ex. 19 | Atomizing | Cu | — | Heated in 40° C. | — | 40 | 11.2 | 1.2 | 2.2 | 83.0 | -82.9 | 2.1 | 2.0 | ⊚⊚ |
| | | | | hot water, | | | | | | | | | | |
| | | | | gum arabic, for | | | | | | | | | | |
| | | | | 3 h (pH 4.5) | | | | | | | | | | |
| Ex. 20 | Atomizing | Cu | — | Heated in 60° C. | — | 40 | 22.0 | 3.2 | 2.8 | 72.3 | -72.1 | 4.1 | 2.6 | ⊚⊚ |
| | | | | hot water for 3 h | | | | | | | | | | |
| Ex. 21 | Atomizing | Cu | — | Heated in 60° C. | — | 40 | 19.1 | 4.4 | 6.0 | 75.4 | -75.0 | 5.3 | 5.8 | ⊚⊚ |
| | | | | hot water, | | | | | | | | | | |
| | | | | gum arabic, | | | | | | | | | | |
| | | | | for 3 h | | | | | | | | | | |
| Comp. 1 | Atomizing | Cu | | — | — | 40 | 72.1 | 30.2 | 30.3 | 48.5 | -22.0 | 31.1 | 30.1 | * |
| Comp. 2 | Atomizing | Cu-8Sn- | | — | — | 40 | 63.4 | 25.1 | 26.3 | 48.0 | -30.7 | 26.0 | 26.1 | * |
| | | 0.5Zn | | | | | | | | | | | | |
| Comp. 3 | Atomizing | Ni | | Cu | Sput- | 40 | 69.3 | 27.3 | 29.1 | 47.4 | -24.8 | 28.2 | 28.9 | * |
| | | | | | tering | | | | | | | | | |
| Comp. 4 | Atomizing | Cu | Immersed in | Cu | Sput- | 40 | 53.7 | 17.2 | 16.6 | 47.2 | -40.4 | 18.1 | 16.4 | * |
| | | | 10 vol % nitric | | tering | | | | | | | | | |
| | | | acid aq. solution | | | | | | | | | | | |
| | | | at 25° C. | | | | | | | | | | | |
| | | | for 10 s | | | | | | | | | | | |
| Comp. 5 | Atomizing | Co | i | Cu | Sput- | 40 | 69.9 | 28.6 | 29.5 | 48.1 | -24.2 | 29.5 | 29.3 | * |
| | | | | | tering | | | | | | | | | |

### INDUSTRIAL APPLICABILITY

The present invention provides a metal powder having improved laser absorbability, which can be preferably used for metal AM, The present invention is an industrially useful invention.

1. A surface-treated metal powder, wherein a surface of the surface-treated metal powder has a lightness L* of 0 or more and 50 or less.

2. The surface-treated metal powder according to claim 1, wherein a surface of the surface-treated metal powder has a color coordinate a* of 20 or less.

3. The surface-treated metal powder according to claim 1, wherein a surface of the surface-treated metal powder has a color coordinate b* of 20 or less.

4. The surface-treated metal powder according to claim 1, wherein a surface of the surface-treated metal powder has a color difference ΔEab of 40 or more, based on an object color of a white plate (lightness L*=94.14, color coordinate a*=−0.90, and color coordinate b*=0.24).

5. The surface-treated metal powder according to claim 1, wherein a surface of the surface-treated metal powder has a color difference ΔL of −35 or less, based on an object color of a white plate (lightness L*=94.14, color coordinate a*=−0.90, and color coordinate b*=0.24).

6. The surface-treated metal powder according to claim 1, wherein a surface of the surface-treated metal powder has a color difference Δa of 20 or less, based on an object color of a white plate (lightness L*=94.14, color coordinate a*=−0.90, and color coordinate b*=0.24).

7. The surface-treated metal powder according to claim 1, wherein a surface of the surface-treated metal powder has a color difference Δb of 20 or less, based on an object color of a white plate (lightness L*=94.14, color coordinate a*=−0.90, and color coordinate b*=0.24).

8. The surface-treated metal powder according to claims 1, wherein the surface-treated metal powder has D50 of 200 μm or less.

9. The surface-treated metal powder according to claim 8, wherein the D50 is 100 μm or less.

10. The surface-treated metal powder according to claim 8, wherein the D50 is 50 μm or less.

11. The surface-treated metal powder according to claims 1, wherein the surface-treated metal powder comprises a surface-treated layer containing one or more elements selected from the group consisting of Ni, Zn, P, W, Sn, Bi, Co, As, Mo, Fe, Cr, V, Ti, Mn, Mg, Si, In and Al.

12. The surface-treated metal powder according to claim 11, wherein the surface-treated layer comprises at least one of Cu and Au.

13. The surface-treated metal powder according to claim 11, wherein the surface-treated layer comprises a roughening-plated layer.

14. The surface-treated metal powder according to claims 1, wherein the metal in the surface-treated metal powder is copper or a copper alloy.

15. A method for producing a laser sintered body, comprising a step of laser-sintering the surface-treated metal powder according to 1 by irradiating the metal powder with laser light to produce a sintered body.

16. The method according to claim 15, wherein the laser light has a wavelength in a range of from 200 to 11000 nm.

17. A method for producing a surface-treated metal powder for laser sintering, comprising a step of subjecting a metal powder to a roughening treatment to obtain a roughening-treated metal powder.

18. The method according to claim 17, wherein after the step of obtaining the roughening-treated metal powder, the method comprises:
a step of subjecting the roughening-treated metal powder to a sputtering treatment;
a step of subjecting the roughening-treated metal powder to a hypochlorite treatment and a dilute sulfuric acid treatment; or
a step of subjecting the roughening-treated metal powder to an electroless plating treatment.

19. A method for producing a surface-treated metal powder for laser sintering, comprising a step of oxidizing the metal powder in an acidic aqueous sulfuric acid solution having a pH of from 3 to 7.

20. The method for producing the surface-treated metal powder according to claim 19, wherein the acidic aqueous sulfuric acid solution is at a temperature in a range of from 30 to 50° C.

21. The method for producing the surface-treated metal powder according to claim 19, wherein the acidic aqueous sulfuric acid solution contains either a natural resin, a polysaccharide, or gelatin.

22. A method for producing a surface-treated metal powder for laser sintering, comprising oxidizing the metal powder in hot water at a temperature of from 40 to 70° C.

23. The method for producing the surface-treated metal powder according to claim 22, wherein the hot water contains either a natural resin, polysaccharide, or gelatin.

24. A method for producing a laser sintered body, comprising: a step of laser-sintering the surface-treated metal powder for laser sintering, produced by the method according to claim 17, by irradiating the metal powder with laser light to produce a sintered body.
